(19) United States
(12) Patent Application Publication
(10) Pub. No.: US 2026/0065814 A1
(43) Pub. Date: Mar. 5, 2026

(54) ELECTRONIC APPARATUS AND CONTROL METHOD

(71) Applicant: CANON KABUSHIKI KAISHA, Tokyo (JP)

(72) Inventor: SHO ICHIKAWA, Kanagawa (JP)

(21) Appl. No.: 19/380,252

(22) Filed: Nov. 5, 2025

Related U.S. Application Data
(63) Continuation of application No. PCT/JP2024/014546, filed on Apr. 10, 2024.

(30) Foreign Application Priority Data
May 17, 2023 (JP) 2023-081831

(51) Int. Cl. G09F 19/12; H04N 13/383; H04N 13/398

(52) U.S. Cl. CPC G09F 19/125; H04N 13/383; H04N 13/398

(57) ABSTRACT

An electronic apparatus includes a display unit that displays first content different from advertisement content, an obtaining unit that obtains eyeball information of a user who is gazing at the first content, and a control unit that sets, based on the eyeball information, second content to be displayed during reproduction of the first content.

### CROSS-REFERENCE TO RELATED APPLICATIONS

This application is a Continuation of International Patent Application No. PCT/JP2024/014546, filed Apr. 10, 2024, which claims the benefit of Japanese Patent Application No. 2023-081831, filed May 17, 2023, both of which are hereby incorporated by reference herein in their entirety.

### BACKGROUND

### Field of the Technology

The present disclosure relates to an electronic apparatus that is wearable and usable by a user.

### Description of the Related Art

An environment for viewing moving image content by an individual using a wearable device such as a head mounted display (HMD) is becoming widespread. When an individual views moving image content, advertisement content may be displayed during reproduction of the moving image content, as with viewing on a television receiver or a tablet computer (PC). In this case, if advertisement contents are unconditionally displayed, uninteresting advertisement content is unpleasant to the user, and the advertising has less effect on a user who is not interested in the advertisement content.

In Japanese Patent Laid-Open No. 2019-40565, a method of changing the frequency or time to display advertisement content in accordance with the degree of interest of a user is described.

However, in Japanese Patent Laid-Open No. 2019-40565, since advertisement content for which the degree of interest of a user is low is also displayed at a low frequency or in a short time, the effect of the advertising is not sufficiently high for a user who views moving image content using a wearable device such as an HMD.

### SUMMARY

The present disclosure has been made in view of the aforementioned problem, and provides technical advantages in displaying content preferred by a user.

In order to solve the aforementioned problems, the present disclosure is directed to an electronic apparatus comprising: a display unit that displays first content different from advertisement content; an obtaining unit that obtains eyeball information of a user who is gazing at the first content; and a control unit that sets, based on the eyeball information, second content to be displayed during reproduction of the first content.

In order to solve the aforementioned problems, the present disclosure is directed to a control method of an electronic apparatus including a display unit that displays first content different from advertisement content, the method comprising: obtaining eyeball information of a user who is gazing at the first content; and setting, based on the eyeball information, second content to be displayed during reproduction of the first content.

Features of the present disclosure will become apparent from the following description of embodiments with reference to the attached drawings.

### BRIEF DESCRIPTION OF THE DRAWINGS

FIG. 1 is a view showing the external appearance of a wearable device according to the present embodiment;

FIG. 2 is a block diagram exemplifying the configuration of the wearable device according to the present embodiment;

FIG. 3A is a flowchart exemplifying control processing of a wearable device according to a first embodiment;

FIG. 3B is a flowchart exemplifying control processing of the wearable device according to the first embodiment;

FIG. 4A is a view illustrating a degree-of-preference estimation method according to the present embodiment;

FIG. 4B is a view illustrating the degree-of-preference estimation method according to the present embodiment;

FIG. 4C is a view illustrating the degree-of-preference estimation method according to the present embodiment;

FIG. 4D is a view illustrating the degree-of-preference estimation method according to the present embodiment;

FIG. 4E is a view illustrating the degree-of-preference estimation method according to the present embodiment;

FIG. 5A is a view illustrating a degree-of-preference updating method according to the present embodiment;

FIG. 5B is a view illustrating the degree-of-preference updating method according to the present embodiment;

FIG. 5C is a view illustrating the degree-of-preference updating method according to the present embodiment;

FIG. 5D is a view illustrating the degree-of-preference updating method according to the present embodiment;

FIG. 6A is a view illustrating an advertisement content setting method according to the present embodiment;

FIG. 6B is a view illustrating the advertisement content setting method according to the present embodiment;

FIG. 6C is a view illustrating the advertisement content setting method according to the present embodiment;

FIG. 7A is a flowchart exemplifying control processing of a wearable device according to a second embodiment;

FIG. 7B is a flowchart exemplifying control processing of the wearable device according to the second embodiment;

FIG. 8A is a view illustrating a degree-of-preference updating method according to the second embodiment;

FIG. 8B is a view illustrating the degree-of-preference updating method according to the second embodiment;

FIG. 9A is a view illustrating the degree-of-preference updating method according to the second embodiment;

FIG. 9B is a view illustrating the degree-of-preference updating method according to the second embodiment;

FIG. 10A is a flowchart exemplifying control processing of a wearable device according to a third embodiment; and

FIG. 10B is a flowchart exemplifying control processing of the wearable device according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Embodiments in which an electronic apparatus according to the present disclosure is applied to a head mounted display that is a wearable device and has a sight line detection function will now be described in detail with reference to the accompanying drawings. Note that the wearable device is not limited to the HMD, and may be a smart device with a sight line detection function such as a smartphone, a tablet computer, an eyeglass-type device, or a wristwatch-type device.

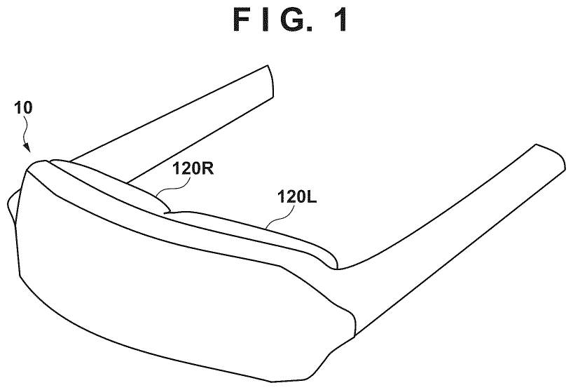

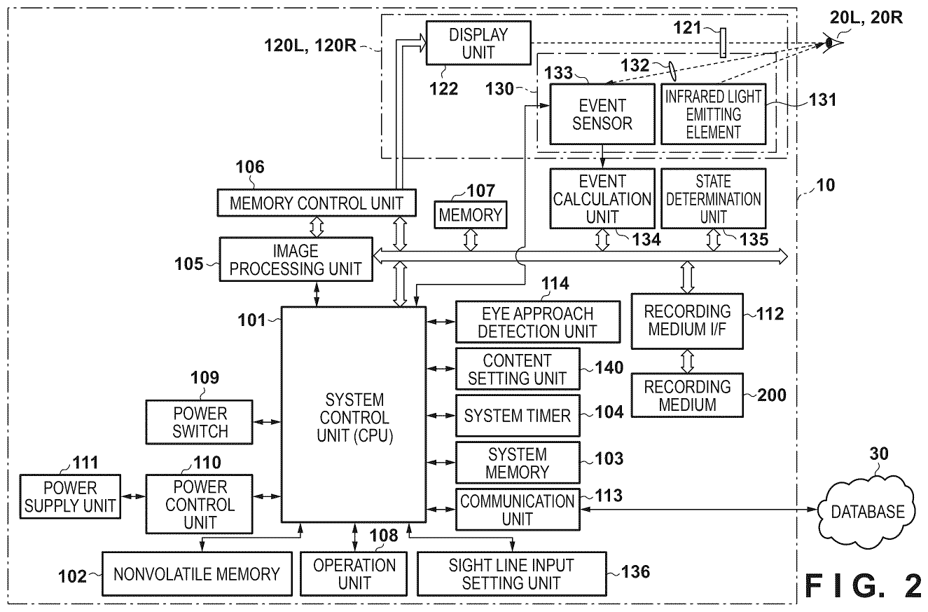

### Apparatus Configuration The configuration and function of a wearable device 10 according to the present embodiment will be described with reference to FIGS. 1 and 2.

FIG. 1 is a view showing the external appearance of the wearable device 10 according to the present embodiment.

A user can use the wearable device 10 according to the present embodiment by wearing it on the head such that its display having a goggles shape are put on both eyes. The wearable device 10 includes a left-eye display device 120L and a right-eye display device 120R. The left-eye display device 120L displays image content to be viewed by the left eye of the user, and the right-eye display device 120R displays image content to be viewed by the right eye of the user. Note that the left-eye display device 120L and the right-eye display device 120R can also display image content such as Virtual Reality (VR) of a 3D video using the parallax between the left and right eyes. Note that the image content is a still image or a moving image. Also, the wearable device 10 according to the present embodiment is of a binocular type including the left-eye display device 120L and the right-eye display device 120R but may be of a monocular type including the left-eye display device 120L or the right-eye display device 120R. Note that in the present embodiment, image content includes a moving image and an advertisement, and the moving image includes audio.

FIG. 2 is a block diagram exemplifying the internal configuration of the wearable device according to the present embodiment.

A system control unit 101 includes an arithmetic processor such as a CPU or an MPU that generally controls the entire wearable device 10, and executes programs stored in a nonvolatile memory 102, thereby implementing processing of flowcharts to be described later. A system memory 103 is a RAM or the like and is also used as a work memory in which constants and variables for the operation of the system control unit 101 and programs read out from the nonvolatile memory 102 are deployed. The system control unit 101 also performs display control of the left-eye display device 120L and the right-eye display device 120R. A system timer 104 is a timer unit that measures time used for various kinds of control and time of an internal clock.

An image processing unit 105 performs, for data from a memory control unit 106, resize processing such as predetermined pixel interpolation or reduction and color conversion processing.

The memory control unit 106 control data transmission/reception between the image processing unit 105 and a memory 107. Data output from the image processing unit 105 is written to the memory 107 via the memory control unit 106. The memory 107 stores display data of content such as a moving image or an advertisement to be displayed on an in-finder display unit 122. The memory 107 has a sufficient storage capacity to store a predetermined number of still images and moving images and audio of a predetermined time. The memory 107 also serves as a memory (video memory) for image display. In addition, the memory 107 stores information (user information) about a user state such as the degree of preference (in other words, preference level or preference score) of a user determined by a state determination unit 135 to be described later. The system control unit 101 transmits the user information stored in the memory 107 to a content setting unit 140 to be described later, and transmits it to a database 30 that is an external apparatus via a communication unit 113.

An operation unit 108 includes operation members such as various kinds of switches and buttons which accept various kinds of operations from the user and notify the system control unit 101 of these operation instructions. The operation unit 108 includes at least a power switch 109.

A power control unit 110 is constituted by, for example, a battery detection circuit, a DC-DC converter, and a switch circuit for changing over the block to be supplied with power, and detects whether a battery has been inserted or not, the type of the battery, and the residual capacity thereof. Further, the power control unit 110 controls the DC-DC converter in accordance with the detection results and an instruction of the system control unit 101, and supplies a necessary voltage for a necessary length of time to each component including the recording medium 200.

A power supply unit 111 comprises a primary battery such as an alkaline battery or a lithium battery, and a secondary battery such as a NiCd battery, a NiMH battery, or a Li-ion battery, or an AC adaptor.

A recording medium interface (I/F) 112 is for interfacing with the recording medium 200 such as a memory card.

A communication unit 113 is communicatively connected to an external apparatus such as a database 30 by a wireless antennal or a wired cable, and transmits and receives data such as image, audio or the like. The communication unit 113 can also be connected to a wireless Local Area Network (LAN) and the Internet. The communication unit 113 can transmit, to the external apparatus, the data recorded on the recording medium 200, and can receive necessary data from the external apparatus. Note that the communication unit 113 is not limited to the wireless LAN, and may use a wireless communication interface such as infrared communication, Bluetooth (registered trademark), Bluetooth (registered trademark) Low Energy, or Wireless USB, or a wired connection interface such as a USB cable, HDMI (registered trademark), or IEEE 1394.

The left-eye display device 120L and the right-eye display device 120R each include an eyepiece part 121, the in-finder display unit 122, and an eyeball detection unit 130. The eyepiece part 121 is the eyepiece part of an eyepiece finder (look-in finder), and the user can view, through the eyepiece part 121, content such as a moving image or an advertisement displayed on the in-finder display unit 122. The in-finder display unit 122 is an electronic viewfinder (EVF) that displays content such as a moving image or an advertisement.

An eye approach detection unit 114 detects whether an eye (an object) has approached or contacted (eye approach) or has moved away from (eye separation) the eyepiece part 121 (approach detection). The system control unit 101 determines, based on the state detected by the eye approach detection unit 114, whether the wearable device 10 is worn by the user. Upon determining that the wearable device 10 is worn by the user, the system control unit 101 powers on the wearable device 10 and switches the in-finder display unit 122 to a display state. Upon determining that the wearable device 10 is not worn by the user, the system control unit 101 powers off the wearable device 10 and switches the in-finder display unit 122 to a non-display state.

When an object has approached, infrared light irradiated from a light emitting unit (not illustrated) of the eye approach detection unit 114 is reflected and is made to be incident on a light receiving unit (not illustrated) of the infrared proximity sensor. In accordance with an incident light amount of the infrared light received by the infrared proximity sensor, it is possible to detect an approach of some kind of physical object to the eyepiece part 121, and discriminate to what level of distance the object has gotten close to the eyepiece part 121 (an eye approach distance). Upon detecting an approach of an object to the eyepiece part 121, the system control unit 101 can cause display of the in-finder display unit 122 to start. With this, it is possible for the in-finder display unit 122 to display without delay as much as possible when a user looks through the eyepiece part 121.

In addition, upon detecting that an object has approached within a predetermined distance with respect to the eyepiece part 121 from a non-eye approach state (no approach state), the eye approach detection unit 114 determines that eye approach is detected and transmits an eye approach detection notification to the system control unit 101. In addition, if an object for which an approach was detected is apart by the predetermined distance or more from an eye approach state (approach state), the eye approach detection unit 114 determines that eye separation is detected, and an eye separation detection notification is transmitted to the system control unit 101. A threshold for detecting eye approach and a threshold for detecting eye separation may be made different such as by providing hysteresis for example. In addition, it is assumed that, after eye approach is detected, there is an eye approach state until eye separation is detected. In addition, it is assumed that, after eye separation is detected, there is a non-eye approach state until eye approach is detected. With this, the system control unit 101 performs display control of the backside display unit 101 and the in-finder display unit 122 in response to an eye approach state or an eye separation state detected by the eye approach detection unit 114.

Note that the eye approach detection unit 114 is not limited to an infrared proximity sensor, and another sensor may be used if it can detect an approach of an object or an eye to be deemed as eye approach.

The eyeball detection unit 130 includes an infrared light emitting element 131, an imaging lens 132, and an event sensor 133, and can detect the information (to be referred to as eyeball information hereinafter) of an eyeball (eye) 20L or 20R of the user who is looking through the eyepiece part 121. Also, the eyeball detection unit 130 can detect the sight line information of the user to the display screen of the in-finder display unit 122. The eyeball detection unit 130 detects sight line information such as the position or direction of a sight line based on the positional relationship between reflected light obtained by reflecting infrared light emitted from the infrared light emitting element 131 by the eyeball (eye) 20L or 20R and the pupil of the eyeball (eye) 20L or 20R.

The infrared light emitting element 131 is a diode that emits infrared light, and irradiates, with the infrared light, the vicinity of the center of the eyeball (eye) 20L or 20R of the user who is looking through the eyepiece part 121. The infrared light emitted from the infrared light emitting element 131 is reflected by the eyeball (eye) 20L or 20R, and the reflected infrared light passes through the imaging lens 132 and reaches the event sensor 133. The imaging lens 132 has a function of reflecting only infrared light and transmitting visible light, and reflected infrared light whose optical path is changed forms an image on the imaging plane of the event sensor 133 through the imaging lens 132.

In a state in which the sight line detection function of the eyeball detection unit 130 is set enabled, the system control unit 101 can determine the sight line input state of the user who is viewing the in-finder display unit 122 through the eyepiece part 121 based on the sight line detection result of the eyeball detection unit 130, and executes processing according to an operation performed by sight line input.

The event sensor 133 is an event base vision sensor that detects a luminance change of light that has entered each pixel and outputs the information (coordinates, polarity, and time) of the pixel whose luminance change is detected as event information asynchronously with other pixels. The event information output from the event sensor 133 includes, for example, the coordinates of the pixel in which the luminance change (event) has occurred, the polarity (positive or negative) of the luminance change, and time information that is the event occurrence time. As compared to a frame-based synchronous sensor such as an existing image sensor, the event sensor 133 eliminates redundancy of information to be output and has characteristics such as high-speed operation, high dynamic range, and low power. Since pieces of pixel information are asynchronously output as the event information, to determine the association between the pieces of event information, various kinds of arithmetic processing need to be performed for a result of accumulating event information that has occurred in a predetermined time.

An event calculation unit 134 performs arithmetic processing for detecting eyeball information from the event information continuously and asynchronously output from the event sensor 133. For example, event information that has occurred in a predetermined time is accumulated, and pieces of accumulated information are processed as a block of data, thereby determining the presence/absence of eyeball information. By changing the event information accumulation time, a plurality of pieces of eyeball information of different occurrence speeds can be detected. The eyeball information includes sight line position information and eyeball movement such as saccade information including the direction and speed of abrupt eyeball movement (saccade) and microsaccade information including the occurrence frequency and amplitude of a microsaccade. Pupil information including the size of a pupil and a change of a pupil and blink information such as the blink speed and count may also be added. Note that the eyeball information described above is merely an example and is not limited to these. The event calculation unit 134 may be configured to map pieces of event information during the accumulation time as image data of one frame based on event occurrence coordinates and perform image processing. This makes it possible to obtain a plurality of pieces of eyeball information from the event information using a method performed in conventional frame-based image processing.

A state determination unit 135 determines the state of the user based on the eyeball information detected by the event calculation unit 134. For example, it is possible to determine a gaze range or a degree of gaze (degree of overlook) based on the frequency and amplitude of a microsaccade. Here, the gaze range is a synonym for an attention range or a notice range. The degree of gaze is an index that is high when the gaze range is narrow and low when the gaze range is wide. The degree of overlook is defined as the antonym of the degree of gaze. A degree of preference, for example, whether the user likes a face is associated with the speed of a microsaccade and the pupil diameter, and can be determined from both parameters. The state determination unit 135 can be formed by, for example, a neural network that receives parameters associated with a microsaccade, a blink, a pupil, and an object identification result and outputs indices (to be referred to as user state information hereinafter) representing the state of the user such as the gaze range or degree of gaze (the degree of overlook as the antonym) and the degree of preference. Note that the state determination unit 135 is not limited to the above-described configuration. Also, eyeball information and the determination result used by the state determination unit 135 are not limited to those described above.

Under the control the system control unit 101, a sight line input setting unit 136 can set the sight line detection function of the eyeball detection unit 130 to an enable or disable state or set parameters or detection conditions to be used by the event calculation unit 134 and the state determination unit 135. The enable or disable state of the sight line detection function or the parameters and detection conditions of the event calculation unit 134 and the state determination unit 135 can be set by, for example, operating a Graphical User Interface (GUI) by the operation unit 108.

In a state in which the sight line detection function of the eyeball detection unit 130 is set disabled, since the sight line detection result of the eyeball detection unit 130 cannot be obtained, the system control unit 101 does not execute estimation of the degree of preference by the state determination unit 135.

The system control unit 101 can detect information about the position and size, on the display screen of the in-finder display unit 122, of an object (for example, a person (face), an animal, or a vehicle) included in moving image content under reproduction. Also, the system control unit 101 can determine, based on the sight line information of the user detected by the eyeball detection unit 130, an object at which the user who is viewing the in-finder display unit 122 through the eyepiece part 121 is gazing.

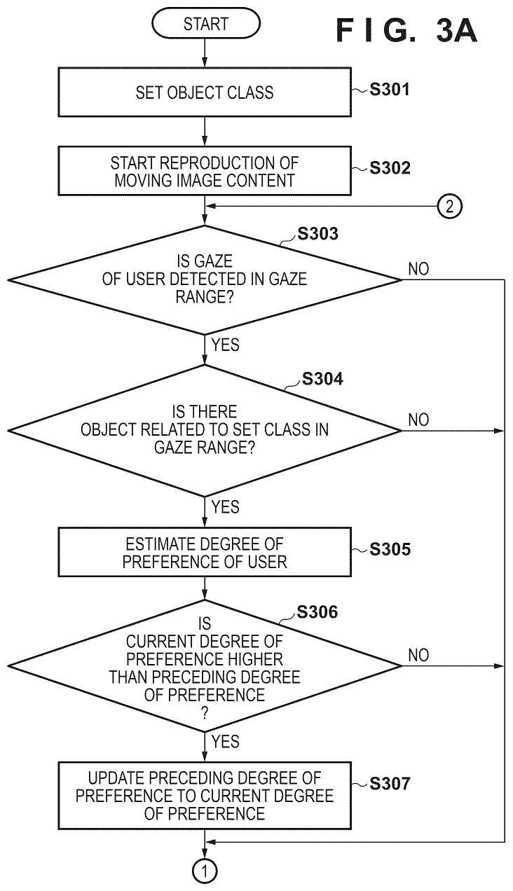

A content setting unit 140 changes advertisement content to be displayed on the in-finder display unit 122 based on the degree of preference of the user. The content setting unit 140 performs control of changing the advertisement content based on, for example, whether the degree of preference estimated by the state determination unit 135 is higher than a threshold or not. Details of control processing will be described later with reference to FIGS. 3A to 10B.

### First Embodiment

Control processing according to a first embodiment will be described next with reference to FIGS. 3A to 6C.

In the first embodiment, during reproduction of moving image content, the degree of preference of a user for an object at which the user is gazing is estimated, and advertisement content according to the degree of preference of the user is displayed.

FIGS. 3A and 3B are flowcharts exemplifying control processing according to the first embodiment.

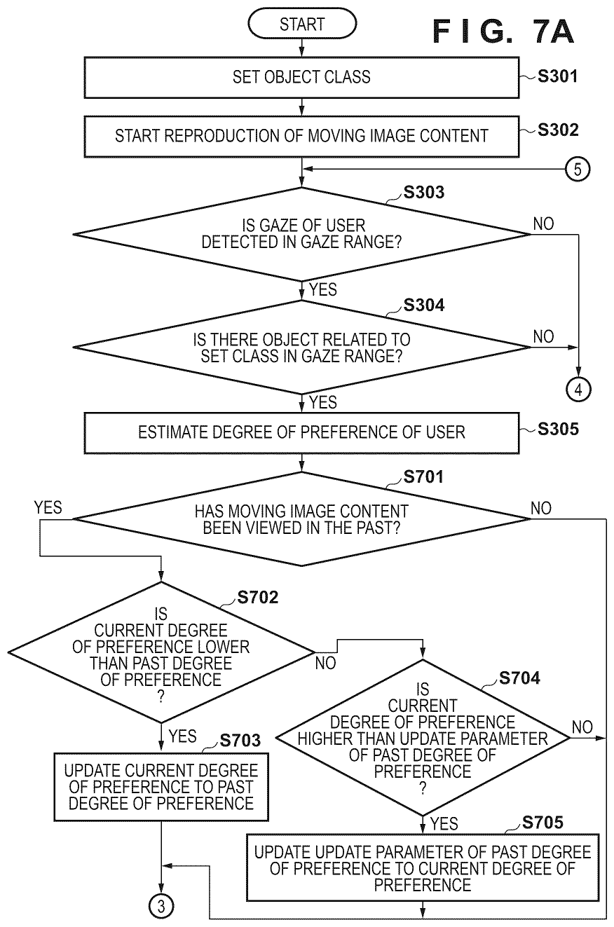

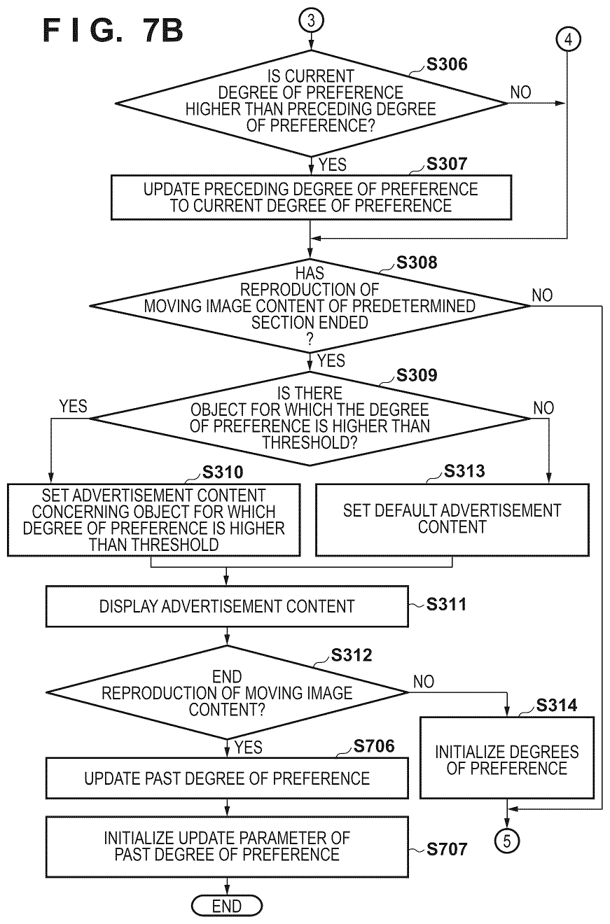

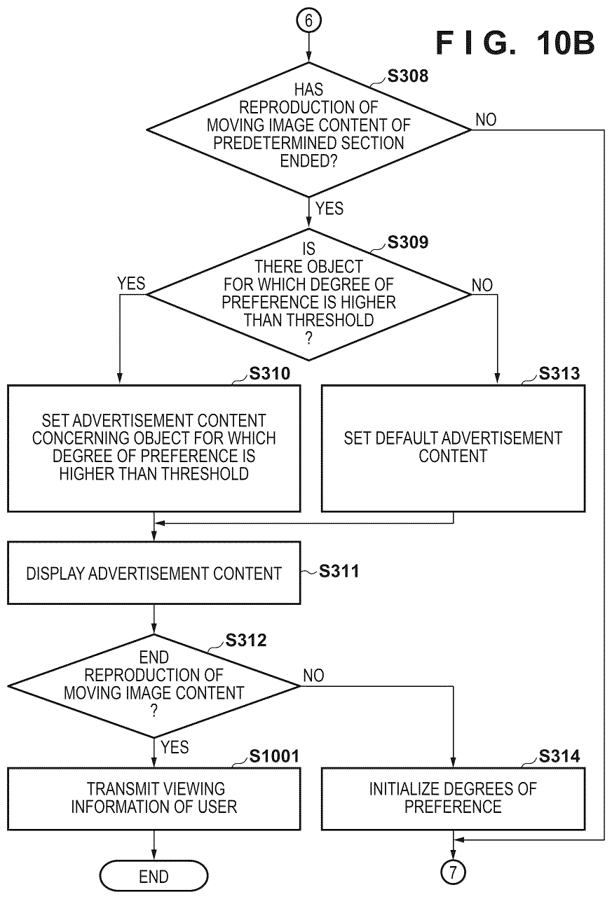

The processing shown in FIGS. 3A and 3B is implemented by a system control unit 101 deploying a program stored in a nonvolatile memory 102 on a system memory 103 and executing it and controlling the constituent elements of a wearable device 10. The processing shown in FIGS. 3A and 3B is started when the wearable device 10 is powered on. This also applies to FIGS. 7A and 7B and FIGS. 10A and 10B to be described later.

In step S301, the system control unit 101 sets the classification or type (to be referred to as the class hereinafter) of an object that is the target for which the state determination unit 135 estimates the degree of preference of the user. The object class includes, for example, at least one of person (face), animal, vehicle, food, and fashion. The user may set the class by operating the GUI via the operation unit 108, or a class associated with moving image content to be reproduced may be automatically set.

In step S302, the system control unit 101 starts reproducing the moving image content.

In step S303, the system control unit 101 determines whether the state determination unit 135 detects the gaze of the user in a range narrower than a predetermined gaze range. Upon determining that the gaze of the user is detected in a range narrower than the predetermined gaze range, the system control unit 101 advances the process to step S304. When it is not determined that the gaze of the user is detected in a range narrower than the predetermined gaze range, the system control unit 101 advances the process to step S308. The method of detecting the gaze range of the user will be described later. Note that in step S303, as the condition to estimate the degree of preference in step S305, the range the user is gazing at is limited to a range narrower than the predetermined gaze range, but the limitation may not be provided.

In step S304, the system control unit 101 determines whether one or a plurality of target objects associated with the class set in step S301 exist in the gaze range of the user detected by the state determination unit 135. Upon determining that a target object exists in the gaze range detected by the state determination unit 135, the system control unit 101 advances the process to step S305. Upon determining that no target object exists in the gaze range detected by the state determination unit 135, the system control unit 101 advances the process to step S308.

In step S305, the system control unit 101 estimates the degree of preference of the user concerning the one or more target objects determined in step S304 and stores the estimated degrees of preference in the memory 107. The degree of preference of the user concerning the target object is estimated from, for example, a pupil diameter change amount, as will be described later in detail. Note that to estimate the degree of preference, not the method using the pupil diameter change amount but another parameter such as the speed of a microsaccade, the degree of gaze, or the gaze time may be used.

In step S306, the system control unit 101 determines whether the degree of preference (to be referred to as a current degree of preference hereinafter) of the user concerning the target object, which is estimated in step S305, is higher than the degree of preference (to be referred to as a preceding degree of preference hereinafter) of the user concerning the same target object, which is stored in the memory 107. Upon determining that the current degree of preference concerning the same target object is higher than the preceding degree of preference, the system control unit 101 advances the process to step S307. Upon determining that the current degree of preference concerning the same target object is equal to or lower than the preceding degree of preference, the system control unit 101 advances the process to step S308.

In step S307, the system control unit 101 updates the preceding degree of preference concerning the same target object, which is stored in the memory 107, to the current degree of preference, and advances the process to step S308.

In step S308, the system control unit 101 determines whether reproduction of the moving image content of a predetermined section is ended. Upon determining that reproduction of the moving image content of the predetermined section is ended, the system control unit 101 advances the process to step S309. Upon determining that reproduction of the moving image content of the predetermined section is not ended, the system control unit 101 returns the process to step S303.

In step S309, the system control unit 101 determines whether in the degrees of preference of the user concerning all target objects determined in step S304, there exists an object for which the degree of preference is higher than a predetermined threshold 601. Upon determining that there exists an object for which the degree of preference is higher than the predetermined threshold 601, the system control unit 101 advances the process to step S310. Upon determining that there does not exist an object for which the degree of preference is higher than the predetermined threshold 601, the system control unit 101 advances the process to step S313. The predetermined threshold 601 will be described later.

In step S310, the system control unit 101 causes a content setting unit 140 to set, as the display target, advertisement content concerning the object for which the degree of preference is higher than the predetermined threshold 601.

Note that in steps S309 and S310, the predetermined threshold 601 is used for the determination. However, the threshold may not be set, and advertisement content concerning the object of the highest degree of preference may be set as the display target.

In step S311, the system control unit 101 reproduces the advertisement content set in step S310 or S313.

In step S312, the system control unit 101 determines whether to end the reproduction of the moving image content. Upon determining to end the reproduction of the moving image content, the system control unit 101 ends the processing. Upon determining not to end the reproduction of the moving image content, the system control unit 101 advances the process to step S314.

In step S313, the system control unit 101 causes the content setting unit 140 to set default advertisement content as the display target.

In step S314, the system control unit 101 causes a memory control unit 106 to initialize the degrees of preference of the user concerning all target objects, which are stored in the memory 107, and returns the process to step S303. Note that in step S314, the degrees of preference stored in the memory 107 are initialized at the end of reproduction of the moving image content, but the degrees of preference may not be initialized.

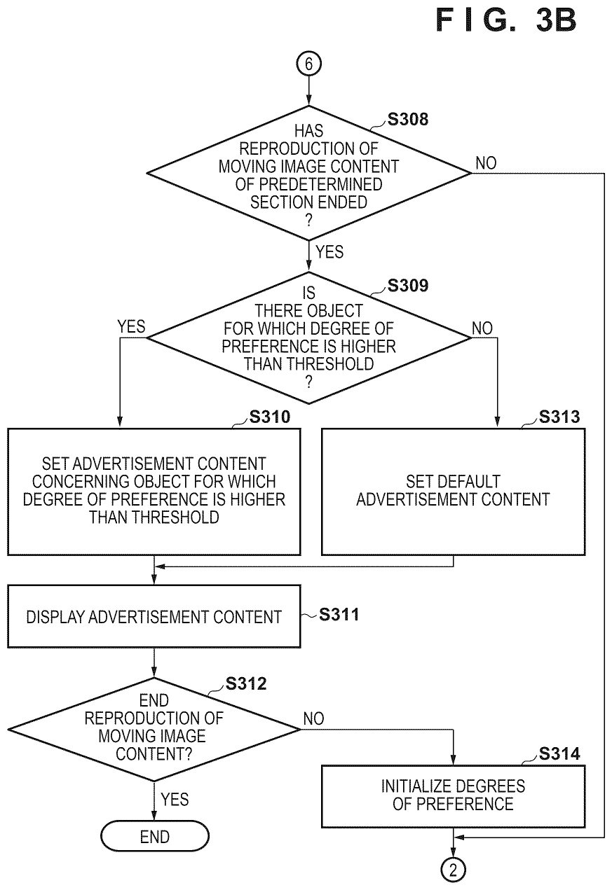

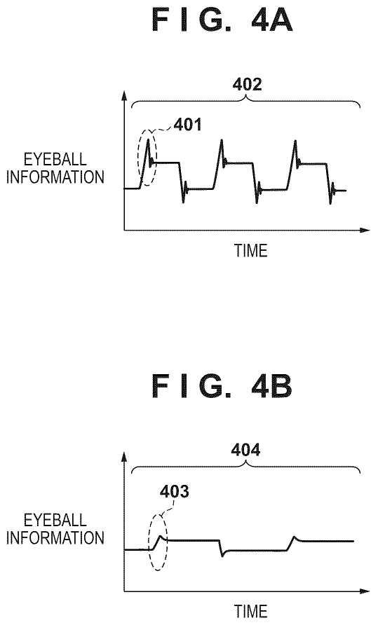

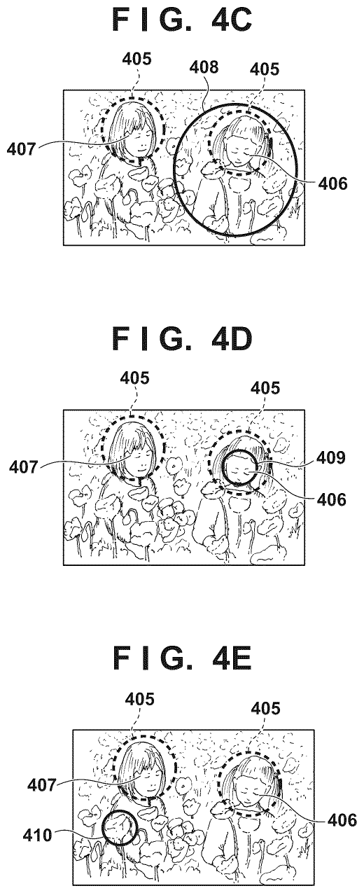

FIGS. 4A to 4E are views for explaining the degree-of-preference estimation method in step S305 of FIG. 3A.

FIGS. 4A and 4B each show microsaccade information that is one of pieces of eyeball information obtained by the event calculation unit 134.

FIGS. 4C to 4E are views each exemplifying the gaze state of the user to the display screen of an in-finder display unit 122. In FIG. 4C, for example, the class of the target object to estimate the degree of preference is person (face), and a predetermined gaze range 405, a first object 406, and a second object 407 are shown.

FIG. 4A exemplifies a microsaccade waveform in a case where the gaze range is relatively wide. The ordinate indicates the position (angle) of the pupil center on an eyeball center coordinate system, and the abscissa indicates time. A region 401 indicates a change of the eyeball position at the time of occurrence of a microsaccade. There is a tendency that the wider the gaze range is, the larger the amplitude of eyeball movement is, and the higher the vibration property is (the lower the attenuation factors is). There is also a tendency that the microsaccade occurrence frequency in a predetermined period is high.

FIG. 4B exemplifies a microsaccade waveform in a case where the gaze range is relatively narrow. Reference numeral 403 indicates a change of the eyeball position at the time of occurrence of a microsaccade. There is a tendency that the narrower the gaze range is, the smaller the amplitude of eyeball movement is, and the lower the vibration property is (the higher the attenuation factors is). There is a tendency that the microsaccade occurrence frequency in a period 404 that is the same as a period 402 in FIG. 4A is low. Thus, the size of the gaze range can be estimated using the feature amount of eyeball movement as a parameter.

FIG. 4C exemplifies the gaze state of the user in the case shown in FIG. 4A where the gaze range is relatively wide. A region 408 is the gaze range of the user. In the example shown in FIG. 4C, for example, the user is overlooking at the first object 406 and the landscape, and the gaze range 408 of the user is larger than the predetermined gaze range 405. In this case, estimation of the degree of preference is not performed.

FIG. 4D exemplifies the gaze state of the user in the case shown in FIG. 4B where the gaze range is relatively narrow. A region 409 is the gaze range of the user. In the example shown in FIG. 4D, the user is gazing at the first object 406, and the gaze range 409 of the user is narrower than the predetermined gaze range 405. In this case, estimation of the degree of preference is performed.

FIG. 4E exemplifies the gaze state of the user in the case shown in FIG. 4B where the gaze range is relatively narrow. A region 410 is the gaze range of the user. In the example shown in FIG. 4E, the user is gazing at a part of the landscape, and the gaze range 410 of the user is narrower than the predetermined gaze range 405. However, since the user is not gazing at the person (face) that is the target object to estimate the degree of preference, estimation of the degree of preference is not performed.

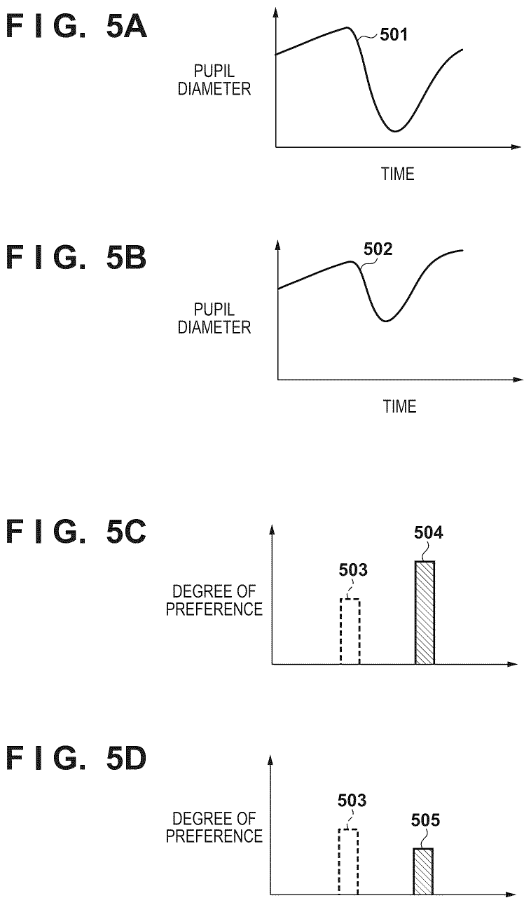

FIGS. 5A and 5B are views for explaining the degree-of-preference updating determination method in step S306 of FIG. 3A.

FIGS. 5A and 5B each exemplify a change of the pupil diameter as one of pieces of eyeball information obtained by the event calculation unit 134.

FIGS. 5C and 5D each exemplify the current degree of preference and the preceding degree of preference estimated by the state determination unit 135. Each of degrees 503 and 504 of preference is, for example, the degree of preference for the first object 406.

FIG. 5A exemplifies the change of the pupil diameter in a case where the degree of preference is relatively high. The ordinate indicates the pupil diameter, and the abscissa indicates time. A waveform 501 exemplifies the change of the pupil diameter when the user views an object that he/she likes. There is a tendency that if the user likes the object, that is, if the degree of preference is high, the change of the pupil diameter is large.

FIG. 5B exemplifies the change of the pupil diameter in a case where the degree of preference is relatively low. The ordinate indicates the pupil diameter, and the abscissa indicates time. A waveform 502 exemplifies the change of the pupil diameter when the user views an object that he/she does not like. There is a tendency that if the user does not like the object, that is, if the degree of preference is low, the change of the pupil diameter is small. Thus, the pupil diameter change amount is used as a parameter, thereby estimating the degree of preference.

FIG. 5C exemplifies a case where the degree of preference is relatively high as shown in FIG. 5A and the current degree of preference estimated by the state determination unit 135 is higher than the preceding degree of preference. When the current degree 504 of preference is higher than the preceding degree 503 of preference, the preceding degree 503 of preference stored in the memory 107 is updated to the current degree 504 of preference.

FIG. 5D exemplifies a case where the degree of preference is relatively low as shown in FIG. 5B and the current degree of preference estimated by the state determination unit 135 is equal to or lower than the preceding degree of preference. When a current degree 505 of preference is lower than the preceding degree 503 of preference, the preceding degree 503 of preference stored in the memory 107 is not updated to the current degree 505 of preference.

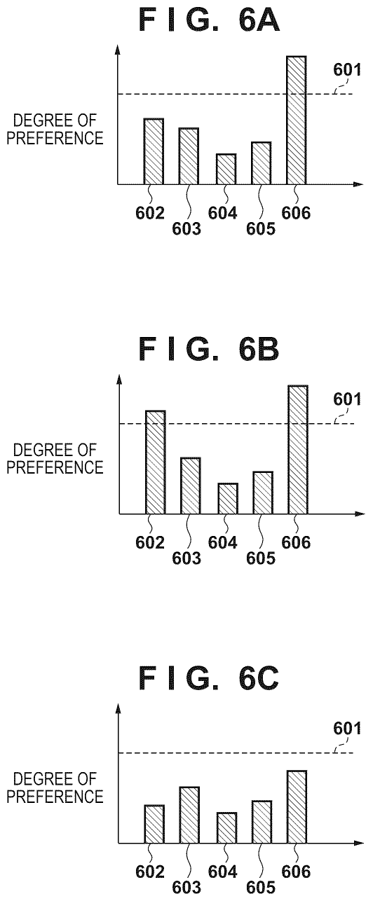

FIGS. 6A to 6C are views for explaining the advertisement content setting method in steps S310 and S313 of FIG. 3B.

For example, assume that the class of the target object to estimate the degree of preference is person (face).

The predetermined threshold 601 is provided for the degree of preference of the user concerning each target object to set advertisement content that is the display target. When there is an object for which the degree of preference of the user is higher than the predetermined threshold 601, advertisement content associated with the object is set as the display target. Degrees 602 to 606 of preference are degrees of preference for objects A to E. The examples of FIG. 6A to 6C show five types of target objects for the sake of simplifying the explanation. However, the number of target objects is not limited to this and may be five or more, or less than five.

FIG. 6A exemplifies the degrees of preference in a case where advertisement content associated with one object is set as the display target. In the example shown in FIG. 6A, the degree 606 of preference for the object E is higher than the predetermined threshold 601. In this case, advertisement content associated with the object E is set as the display target. For example, advertisement content in which the object E appears is set as the display target.

FIG. 6B exemplifies the degrees of preference in a case where advertisement content associated with a plurality of objects is set as the display target. The degree 602 of preference for the object A and the degree 606 of preference for the object E are higher than the predetermined threshold 601. In this case, an advertisement content associated with the object A and the object E is set as the display target. For example, advertisement content in which the object A and the object E appear or the object A or the object E appears is set as the display target.

FIG. 6C exemplifies the degrees of preference in a case where default advertisement content is set as the display target. All the degrees 602 to 606 of preference are lower than the predetermined threshold 601. In this case, default advertisement content is set as the display target.

Note that, as the display target advertisement content, an example in which an object for which the degree of preference of the user is higher than the predetermined threshold 601 appears has been described, but other advertisement content associated with the object may be set, or the advertisement content may be changed in accordance with the setting of the class of the object.

As described above, according to the first embodiment, during reproduction of moving image content, the degree of preference of the user for an object at which the user is gazing is estimated, and advertisement content according to the degree of preference of the user is displayed. This can increase the effect of the advertising during reproduction of the moving image content.

### Second Embodiment

A second embodiment will be described next with reference to FIGS. 7A to 9B.

In the second embodiment, during reproduction of moving image content, the degree of preference of a user for an object at which the user is gazing is estimated, and advertisement content according to the degree of preference of the user is displayed in consideration of the past degree of preference that was estimated when the user viewed the same moving image content in the past.

Note that in the second embodiment, the configuration and function of a wearable device 10 are the same as the configuration and function shown in FIGS. 1 and 2 of the first embodiment.

FIGS. 7A and 7B are flowcharts exemplifying control processing according to the second embodiment. The same step numbers as in FIGS. 3A and 3B denote the same processes in FIGS. 7A and 7B, and a description thereof will be omitted.

In step S701, a system control unit 101 determines whether the moving image content started to be reproduced in step S302 has been viewed in the past. Upon determining that the moving image content has been viewed in the past, the system control unit 101 advances the process to step S702. Upon determining that the moving image content has not been viewed in the past, the system control unit 101 advances the process to step S306.

In step S702, the system control unit 101 determines whether the degree of preference (current degree of preference) of the user concerning the target object, which is estimated in step S305, is lower than the degree of preference (to be referred to as a past degree of preference hereinafter) of the user concerning the target object, which is estimated when the moving image content was viewed in the past. Note that the past degree of preference was stored in a nonvolatile memory 102 at the time of past reproduction of the moving image content, and is loaded into a memory 107 in current reproduction of the content. Upon determining that the current degree of preference is lower than the past degree of preference, the system control unit 101 advances the process to step S703. Upon determining that the current degree of preference is higher than the past degree of preference, the system control unit 101 advances the process to step S704.

In step S703, the system control unit 101 updates the current degree of preference stored in the memory 107 to the past degree of preference, and advances the process to step S306. The degree-of-preference updating determination method will be described later.

In step S704, the system control unit 101 determines whether the current degree of preference is higher than the update parameter of the past degree of preference. Note that the update parameter of the past degree of preference was stored in the nonvolatile memory 102 at the time of past reproduction of the moving image content, and is loaded into the memory 107 in current reproduction of the content. Upon determining that the current degree of preference is higher than the update parameter of the past degree of preference, the system control unit 101 advances the process to step S705. Upon determining that the current degree of preference is equal to or lower than the update parameter of the past degree of preference, the system control unit 101 advances the process to step S306.

In step S705, the system control unit 101 updates the update parameter of the past degree of preference stored in the memory 107 to the current degree of preference, and advances the process to step S306.

In step S706, the system control unit 101 updates the past degree of preference stored in the memory 107 to the update parameter of the past degree of preference updated in step S705 and stores it in the nonvolatile memory 102. The updating determination method for the update parameter of the past degree of preference will be described later.

In step S707, the system control unit 101 causes a memory control unit 106 to initialize the update parameter of the past degree of preference stored in the memory 107, and ends the processing.

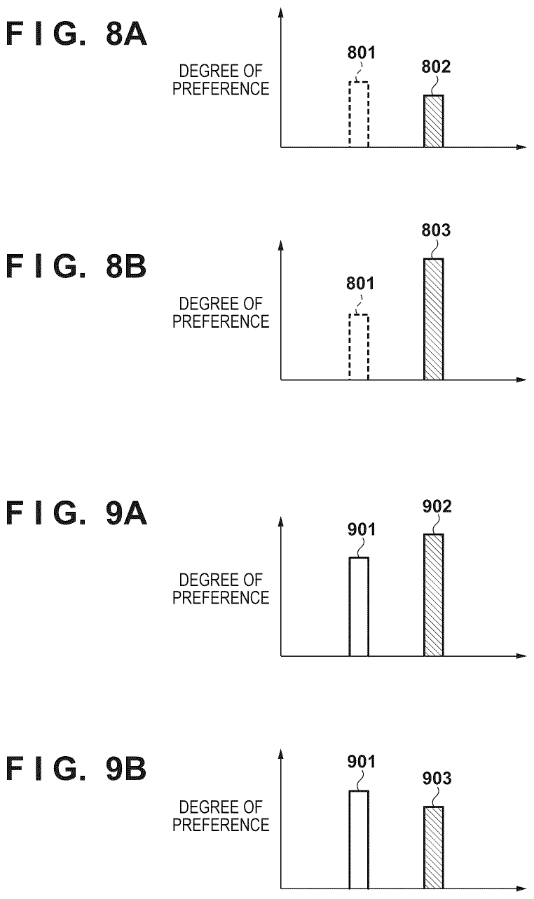

FIGS. 8A and 8B are views for explaining the degree-of-preference updating determination method in step S702 of FIG. 7A.

FIGS. 8A and 8B each exemplify the current degree of preference and the past degree of preference estimated by a state determination unit 135. A past degree 801 of preference is, for example, a past degree of preference for a first object 406 shown in FIGS. 4C to 4E. The past degree 801 of preference is a degree of preference estimated at the time of past reproduction of the moving image content, and no value exists when the same moving image content is reproduced for the first time.

FIG. 8A exemplifies a case where the current degree of preference estimated by the state determination unit 135 is lower than the past degree of preference. When a current degree 802 of preference is lower than the past degree 801 of preference, the current degree 802 of preference stored in the memory 107 is updated to the past degree 801 of preference.

FIG. 8B exemplifies a case where the current degree of preference estimated by the state determination unit 135 is higher than the past degree of preference. A degree 803 of preference is a current degree of preference estimated by the state determination unit 135 during current reproduction of the moving image content. When the degree 803 of preference is higher than the past degree 801 of preference, the past degree 801 of preference stored in the memory 107 is not updated.

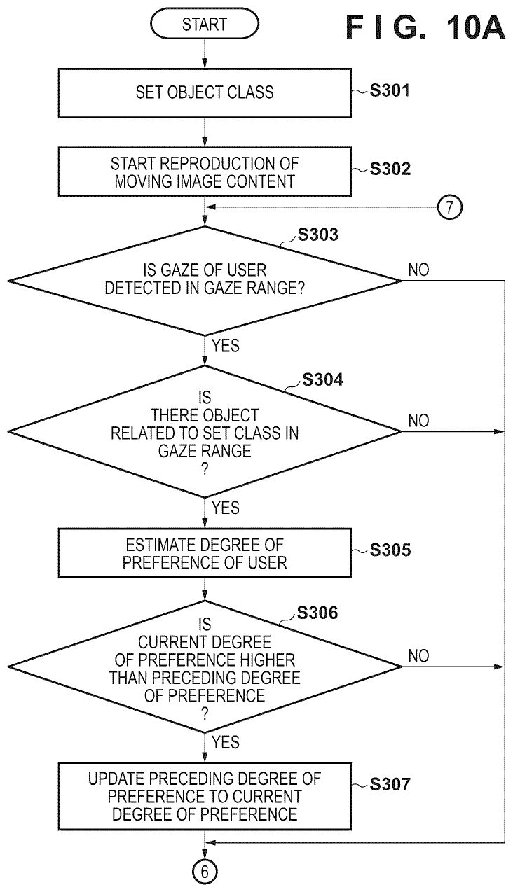

FIGS. 9A and 9B are views for explaining the updating determination method for the update parameter of the degree of preference in step S705 of FIG. 7A.

FIGS. 9A and 9B each exemplify the update parameters of the current degree of preference and the past degree of preference estimated by the state determination unit 135. An update parameter 901 is, for example, the update parameter of the past degree of preference for the first object 406 shown in FIGS. 4C to 4E. The update parameter 901 of the past degree of preference is a parameter used to update the past degree of preference in the next reproduction after the end of past reproduction of the moving image content.

FIG. 9A exemplifies a case where the current degree of preference estimated by the state determination unit 135 is higher than the update parameter of the past degree of preference. When a current degree 902 of preference is higher than the update parameter 901 of the past degree of preference, the update parameter 901 of the past degree of preference stored in the memory 107 is updated to the current degree 902 of preference.

FIG. 9B exemplifies a case where the current degree of preference estimated by the state determination unit 135 is equal to or lower than the update parameter of the past degree of preference. When a current degree 903 of preference is lower than the update parameter 901 of the past degree of preference, the update parameter 901 of the past degree of preference stored in the memory 107 is not updated.

Note that the method of correcting the variation of the estimation result of the degree of preference in steps S702 and S703 is not limited to the method of updating the current degree of preference to the past degree of preference, and another correction method may be used. For example, a correction method of storing a plurality of past degrees of preference for the same target object and obtaining the moving average value to the current degree of preference or obtaining a median may be used

As described above, according to the second embodiment, during reproduction of moving image content, it is possible to estimate the degree of preference of the user for an object at which the user is gazing and display advertisement content according to the degree of preference of the user in consideration of the past degree of preference estimated when the user viewed the same moving image content in the past. By considering the past degree of preference at the time of past reproduction of the moving image content, the variation of the estimation result of the degree of preference for the same moving image content can be corrected, and the effect of the advertising during reproduction of the moving image content can further be increased.

### Third Embodiment

A third embodiment will be described next with reference to FIGS. 10A and 10B.

In the third embodiment, during reproduction of moving image content, the degree of preference of a user for an object at which the user is gazing is estimated, advertisement content according to the degree of preference of the user is displayed, and the viewing information of the user is transmitted to an external database 30.

Note that in the third embodiment, the configuration and function of a wearable device 10 are the same as the configuration and function shown in FIGS. 1 and 2 of the first embodiment.

FIGS. 10A and 10B are flowcharts exemplifying control processing according to the third embodiment. The same step numbers as in FIGS. 3A and 3B denote the same processes in FIGS. 10A and 10B, and a description thereof will be omitted.

In step S1001, a system control unit 101 causes a communication unit 113 or transmit the viewing information of the user to the database 30 and ends the processing. The viewing information of the user includes, for example, information such as the name of the moving image content, the degree of preference of the user for each object, and the setting frequency of advertisement content. Note that the timing of transmitting the viewing information of the user to the external apparatus is not limited to a timing after the end of reproduction of the moving image content and may be another timing.

As described above, according to the third embodiment, during reproduction of moving image content, the degree of preference of the user for an object at which the user is gazing is estimated, advertisement content according to the degree of preference of the user is displayed, and the viewing information of the user is transmitted to the external database 30. This can increase the effect of the advertising at the time of reproduction of the moving image content. In addition, since the viewing information of the user can be fed back to an external apparatus that creates and supplies advertisement content, it is possible to promote creation and supply of advertisement content having a higher effect.

In the above-described embodiments, the advertisement content as the display target may be set by the user operating the GUI via the operation unit 108. Also, when setting the object class, a plurality of classes, for example, person (face) and animal, may be set.

According to the present disclosure, it is possible to display that the user likes.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic apparatus comprising:
a display unit that displays first content different from advertisement content;
an obtaining unit that obtains eyeball information of a user who is gazing at the first content; and
a control unit that sets, based on the eyeball information, second content to be displayed during reproduction of the first content.

2. The electronic apparatus according to claim 1, further comprising an estimation unit that estimates, based on the eyeball information, a degree of preference of the user who is viewing the first content,
wherein the control unit sets, based on the degree of preference of the user, the second content to be displayed during the reproduction of the first content.

3. The electronic apparatus according to claim 2, wherein the estimation unit estimates the degree of preference of the user based on an object at which the user is gazing for the first content.

4. The electronic apparatus according to claim 3, wherein the estimation unit estimates the degree of preference of the user based on one or a plurality of objects at which the user is gazing in a range narrower than a predetermined range.

5. The electronic apparatus according to claim 3, wherein
the estimation unit estimates the degree of preference of the user during the reproduction of the first content of a predetermined section,
the degree of preference of the user estimated based on a predetermined object is stored in a storage unit, and
when a current degree of preference newly estimated based on the predetermined object is higher than a preceding degree of preference stored in the storage unit, the preceding degree of preference stored in the storage unit is updated to the current degree of preference.

6. The electronic apparatus according to claim 3, wherein the control unit compares the degree of preference of the user with a threshold and sets predetermined content as the second content when there is no object for which the degree of preference of the user is higher than the threshold, and
when there is an object for which the degree of preference of the user is higher than the threshold, the control unit sets content associated with the object as the second content.

7. The electronic apparatus according to claim 6, wherein when there are a plurality of objects for which the degree of preference of the user is higher than the threshold, the control unit sets content associated with the plurality of objects as the second content.

8. The electronic apparatus according to claim 3, wherein when the first content has been viewed in the past, the control unit determines whether a current degree of preference estimated based on a predetermined object is higher than a past degree of preference estimated based on the predetermined object when the first content was viewed in the past,
when the current degree of preference is lower than the past degree of preference, the control unit updates the current degree of preference to the past degree of preference, and
when the current degree of preference is higher than the past degree of preference and when the past degree of preference is higher than a predetermined degree of preference, the control unit updates the past degree of preference to the predetermined degree of preference.

9. The electronic apparatus according to claim 1, wherein when ending the reproduction of the first content, the control unit transmits viewing information of the user concerning the first content to an external apparatus.

10. The electronic apparatus according to claim 3, wherein when ending the reproduction of the first content, the control unit transmits viewing information of the user concerning the first content to an external apparatus, and
the viewing information of the user includes information of the first content, the degree of preference of the user for each object, and a setting frequency of the second content.

11. The electronic apparatus according to claim 2, further comprising a setting unit that sets a class of a target object to estimate the degree of preference of the user,
wherein the class includes at least one of person (face), animal, vehicle, food, and fashion.

12. The electronic apparatus according to claim 2, wherein estimation of the degree of preference of the user by the estimation unit can be set enabled or disabled.

13. The electronic apparatus according to claim 1, wherein the eyeball information includes at least one of an occurrence frequency of a microsaccade, an amplitude of a microsaccade, sight line position information, a direction of a saccade, a speed of a saccade, a size of a pupil, and a change of a pupil diameter.

14. The electronic apparatus according to claim 1, wherein the first content is a moving image content, and the second content is an advertisement content.

15. The electronic apparatus according to claim 1, wherein the electronic apparatus is a head mounted display.

16. A control method of an electronic apparatus including a display unit that displays first content different from advertisement content, the method comprising:
obtaining eyeball information of a user who is gazing at the first content; and
setting, based on the eyeball information, second content to be displayed during reproduction of the first content.

17. A non-transitory computer-readable storage medium storing a program for causing a computer to function as an electronic apparatus comprising:
a display unit that displays first content different from advertisement content;
an obtaining unit that obtains eyeball information of a user who is gazing at the first content; and
a control unit that sets, based on the eyeball information, second content to be displayed during reproduction of the first content.
